(19) United States
(12) Patent Application Publication
(10) Pub. No.: US 2010/0198805 A1
(43) Pub. Date: Aug. 5, 2010

(54) METHOD AND APPARATUS FOR GENERATING AND DISPLAYING IMAGE

(75) Inventors: Jin-seok CHOI, Yongin-si (KR); Yong-jo KIM, Yongin-si (KR); Hee-soo LEE, Hwaseong-si (KR); Houng-sog MIN, Ansan-si (KR); Hong-seok PARK, Ansan-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/554,127

(22) Filed: Sep. 4, 2009

(30) Foreign Application Priority Data
Feb. 3, 2009 (KR) 10-2009-0008541

(51) Int. Cl. G06F 17/30

(52) U.S. Cl. 707/711; 707/E17.107

(57) ABSTRACT

Provided is a method of generating image files, the method including: obtaining a first web page; extracting, from the first web page, link information, through which moving a second web page from the first web page is performed; downloading the second web page according to the extracted link information; and converting the first and second web pages into respective image files.

### CROSS-REFERENCE TO RELATED PATENT APPLICATION

This application claims priority from Korean Patent Application No. 10-2009-0008541, filed Feb. 3, 2009, in the Korean Intellectual Property Office, the disclosure of which is incorporated herein in its entirety by reference.

### BACKGROUND OF THE INVENTION

1. Field of the Invention

Methods and apparatuses consistent with the present invention relate to generating an image file converted from a web page, and displaying the converted image.

2. Description of the Related Art

Small-size mobile multimedia devices have become widely popular. In order to view Internet websites on the mobile multimedia devices, the Internet is accessed and a web browser is installed in the mobile multimedia devices. However, if the mobile multimedia devices do not have a network function or a web browser, the websites may not be viewed.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

According to an aspect of one or more exemplary embodiments of the present invention, there is provided a method and apparatus for generating and displaying image files, by which web pages may be efficiently accessed even though wire or wireless communication is not available and there is no web browser.

According to an exemplary aspect of the present invention, there is provided a method of generating an image file, the method including: extracting link information through which movement from a requested web page to another web page is possible; downloading the requested web page and web pages to move according to the extracted link information; and converting the downloaded web pages into their respective image files.

The method may further include: providing unique identifications (IDs) to the image files based on the link information; and generating an index file including the unique IDs.

The method may further include storing location information of the link information in the web pages to the index file.

The storing to the index file may include: converting location information of the link information extracted from the web pages into corresponding location information in the image files converted from the web pages; and storing the corresponding location information in the image files to the index file.

The IDs of the image files may have a tree structure in which the IDs are allocated to respective nodes.

The depth of the tree structure may be determined according to an external input signal.

The method may further include storing the index file and the image files to a predetermined storage device.

According to another exemplary aspect of the present invention, there is provided a method of displaying an image file, the method including: extracting an index file from a storage device which stores the index file, the index file including IDs provided to the image files based on image files converted from a web page and link information through which movement from the web page to another web page is possible and location information of the link information in the image files corresponding to the location information of the link information in the web pages; and displaying predetermined image files based on the extracted index file.

The IDs of the image files may have a tree structure in which the IDs are allocated to respective nodes.

The displaying of the image files may include: extracting the location information of the link information in the image files from the extracted index file; and displaying the image files having IDs corresponding to the link information in the extracted location information.

According to another exemplary aspect of the present invention, there is provided an apparatus for generating an image file, the apparatus including: a link information extracting unit for extracting link information through which movement from a requested web page to another web page is possible; a web page requesting unit downloading the requested web page and web pages to move according to the extracted link information; and an image file generating unit for converting the downloaded web pages into their respective image files.

According to another exemplary aspect of the present invention, there is provided an apparatus of displaying an image file, the apparatus including: an index file interpreting unit for extracting an index file from a storage device which stores the index file, the index file including IDs provided to the image files based on image files converted from a web page and link information through which movement from the web page to another web page is possible and location information of the link information in the image files corresponding to the location information of the link information in the web pages; and an image file displaying unit for displaying predetermined image files based on the extracted index file.

### BRIEF DESCRIPTION OF THE DRAWINGS

The above and other aspects of the present invention will become more apparent by describing certain exemplary embodiments of the present invention with reference to the accompanying drawings, in which:

FIG. 1 is a block diagram of an apparatus for generating an image file according to an exemplary embodiment of the present invention;

FIGS. 2A and 2B illustrate image files converted from a web page;

FIG. 3 illustrates a tree diagram of an index file;

FIG. 4 illustrates main elements of each of the respective nodes;

FIGS. 5A and 5B respectively illustrate the index file and image files stored in a storage device;

FIG. 6 illustrates an exemplary tree structure stored in an index file;

FIG. 7 is a block diagram of an apparatus for displaying an image according to an exemplary embodiment of the present invention;

FIG. 8 is a flowchart illustrating a method of generating an image file according to an exemplary embodiment of the present invention; and

FIG. 9 is a flowchart illustrating a method of displaying an image according to another exemplary embodiment of the present invention.

### DETAILED DESCRIPTION OF EXEMPLARY EMBODIMENTS

Exemplary embodiments of the present invention are described in greater detail below with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

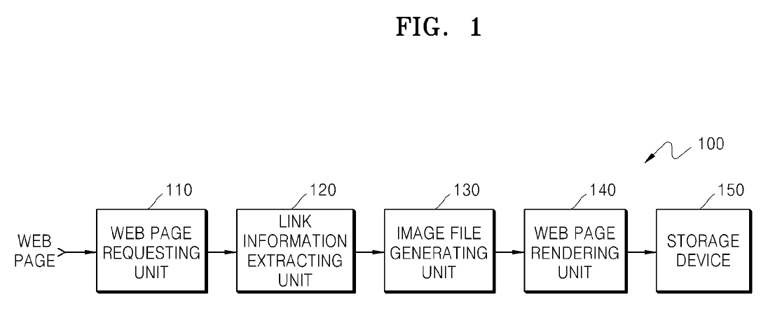

FIG. 1 is a block diagram of an apparatus 100 for generating an image file according to an exemplary embodiment of the present invention.

Referring to FIG. 1, the apparatus 100 for generating an image file includes a web page requesting unit 110, a link information extracting unit 120, an image file generating unit 130, a web page rendering unit 140, and a storage device 150.

The web page requesting unit 110 downloads content of a uniform resource locator (URL), that is, a web page, requested by a user through a predetermined wire or wireless communication network, for example, the Internet.

The link information extracting unit 120 extracts link information through which a movement of content from the downloaded web page to another web page is performed. A link tag, for example, <a> connected to another URL from the downloaded web page is recognized. Based on the recognized link tag, a request to download the web page or web pages indicated by the link tag is submitted to the web page requesting unit 110. The web page requesting unit 110 downloads the web pages indicated by the link tag. In this regard, link information may be extracted from the newly downloaded web pages and the download of the different web pages may be performed. The user may determine the frequency of repeatedly downloading, that is, the depth, as described in detail below.

The image file generating unit 130 converts the downloaded web pages into image files of a predetermined format. For example, the format of the image files may be joint photographic experts group (JPG) or graphics interchange format (GIF).

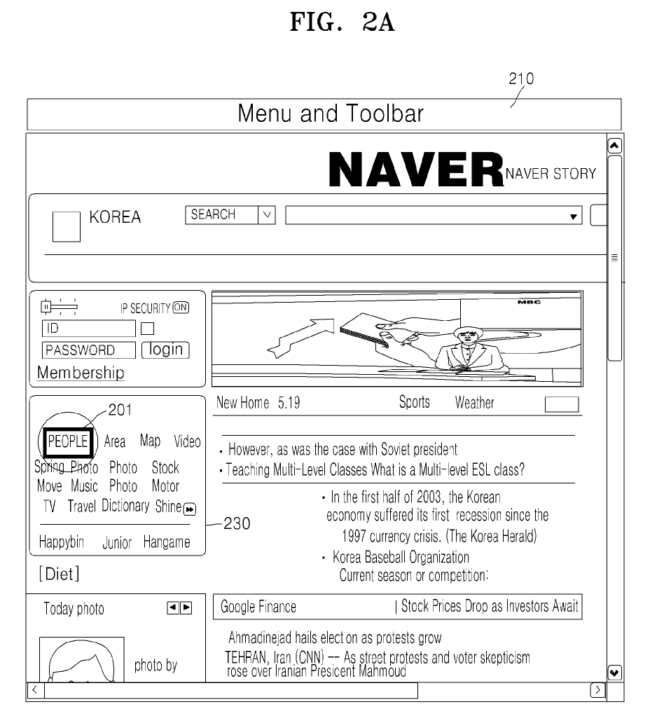

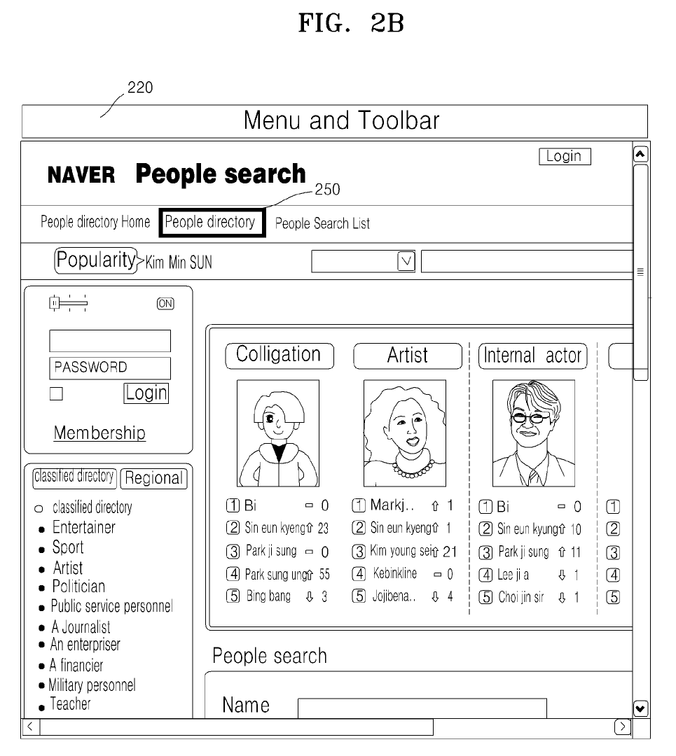

The web page rendering unit 140 provides unique identifications (IDs) to the image files converted based on the link information and generates an index file including the unique IDs. The web page rendering unit 140 stores location information of the link information in the web pages to the index file. More specifically, the web page rendering unit 140 extracts the information of the location, where the link information extracted from the web page exists, and converts the information of the location into information of a corresponding location in the image files. The converted location information is stored in the index file, as described below with reference to FIG. 2.

FIGS. 2A and 2B illustrate first and second image files 210 and 220 converted from a corresponding web page. Referring to FIG. 2A, the first image file 210 is an image file converted from a requested or first web page. Since the coordinates of the web page may be different from the coordinates of the first image file 210, a location of link information 201 related to ‘people’ in the first web page may be different from the location of link information in the first image file 210. When the first web page is converted to the first image file 210, the web page rendering unit 140 may convert the location of the link information 201 in the web page to correspond to the location of the link information 201 in the first image file 210, in order to have the same link information in the first web page and the first image file 210. Referring to FIG. 2B, the second image file 220 is an image file linked from the first image file 210 according to link information 201 related to ‘people’. Other image files may be converted from the first image file 210 based on other links.

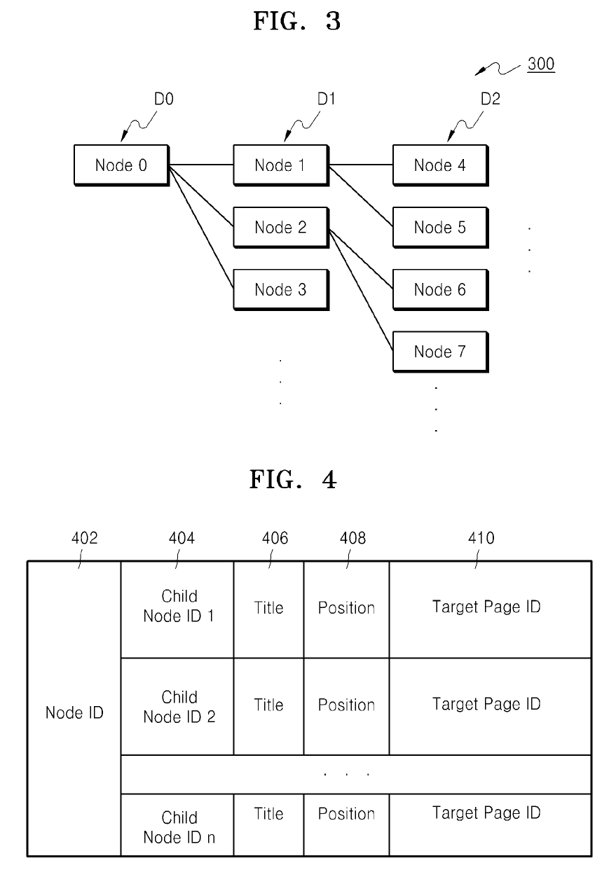

The index file may have a tree structure in which node information is allocated to respective nodes. FIG. 3 illustrates a tree diagram 300 of the index file.

The depth D0 of node 0, which is a parent node, is ‘0.’ Node 1, node 2, and node 3 are child nodes. The depth D1 of the nodes 1, 2 and 3 is ‘1.’ Node 4, node 5, node 6, and node 7 are grandchild nodes. The depth D2 of the nodes 4, 5, 6 and 7 is ‘2.’ According to the selection by a user, a depth level may be increased or decreased. The web page corresponding to the parent node is the first web page, the web pages corresponding to the child nodes are the second web pages linked to the first web page corresponding to the parent node, and the web pages corresponding to the grandchild nodes are the third web pages linked to the second web pages corresponding to the child nodes.

FIG. 4 illustrates main elements of each of the respective nodes. Referring to FIG. 4, the nodes include a node ID 402 corresponding to the parent node, at least one child node ID 404, at least one title 406, at least one position 408, and at least one target page ID 410. According to the depth of the respective nodes, node IDs of other nodes may be further included. The position denotes coordinates of the link information located in an image file converted from the web page. The target page ID denotes an ID of an image file to move based on the link information and may be, for example, a file name of the image file.

The web page rendering unit 140 stores the index file and the image files to the storage device 150. The storage device 150 may be included in the apparatus for generating an image or may be separate from the apparatus for generating an image. The storage device 150 may be a mobile storage device which may be detachable from the apparatus. However, the storage device 150 is not limited to the mobile storage device. The web page rendering unit 140 may generate a predetermined directory in the storage device 150 and store the index file and the image files in the storage device 150.

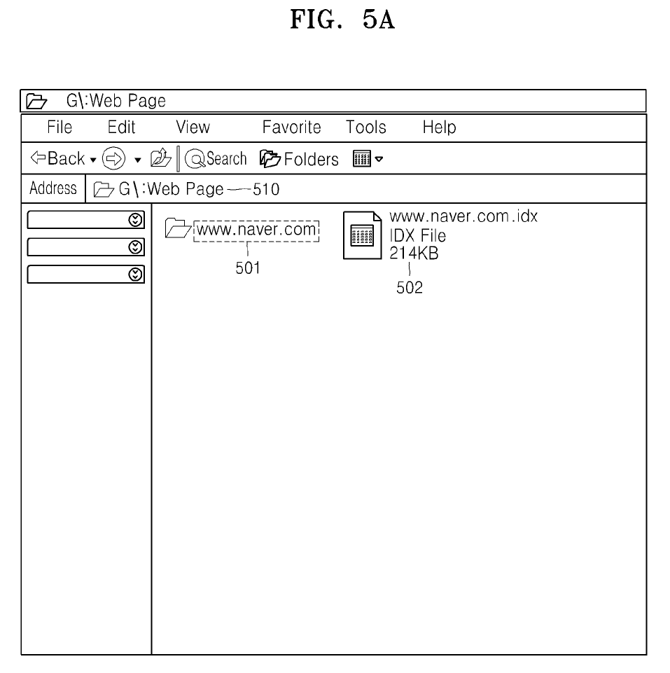

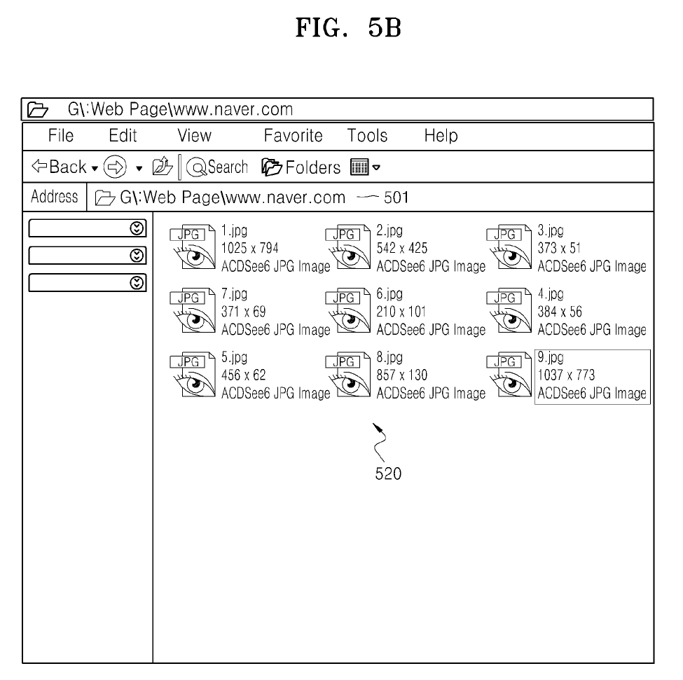

FIGS. 5A and 5B illustrate the index file and the image files stored in the storage device 150. Referring to FIG. 5A, a directory 501 indicating an address of the first web page and an index file 502 generated based on the first web page are stored in a predetermined directory 510. Referring to FIG. 5B, image files 520 stored in the directory 501 are illustrated.

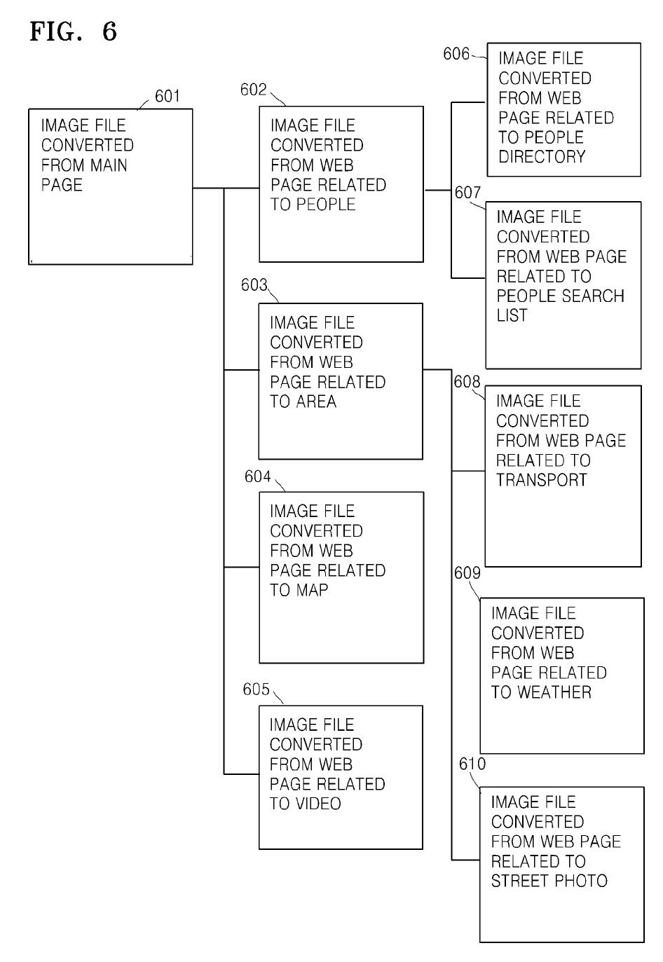

FIG. 6 illustrates an exemplary tree structure stored in an index file. Referring to FIG. 6, an index file generated with respect to the image files 520 of FIG. 5B is illustrated. In FIG. 6, an image file 601 converted from the first web page corresponds to a parent node. Image files 602, 603, 604, and 605 corresponding to child nodes linked to the image file 601 corresponding to the parent node are illustrated. Image files 606 and 607 corresponding to grandchild nodes linked to the image file 602 corresponding to the child node, and image files 608, 609, and 610 corresponding to grandchild nodes linked to the image file 603 corresponding to the child node are illustrated. For example, the image file 601 corresponding to the parent node is an image file converted from a main page of ‘naver.com’. The image files 602, 603, 604, and 605 corresponding to the child nodes are converted respectively from a web page related to ‘people’ linked to the main page, a web page related to ‘area’, a web page related to ‘map’, and a web page related to ‘video’, as illustrated in a field 230 of FIG. 2. The image files 606 and 607 corresponding to the grandchild nodes are converted respectively from a web page related to ‘people directory’ linked to the web page relating to ‘people’, and a web page related to ‘people search list’ linked to the web page related to ‘people’. The image files 608, 609 and 610 corresponding to the grandchild nodes are converted from a web page related to ‘transport’ linked to the web page relating to ‘area’, a web page related to ‘weather’ linked to the web page relating to ‘area’, and a web page related to ‘street photo’ linked to the web page related to ‘area’.

As described above, the image files converted from the web pages may be generated in the apparatus 100 for generating an image and stored in the storage device. Accordingly, the web pages may be viewed in a mobile electronic device without connecting to a wire or wireless communication network, thereby increasing the users' convenience.

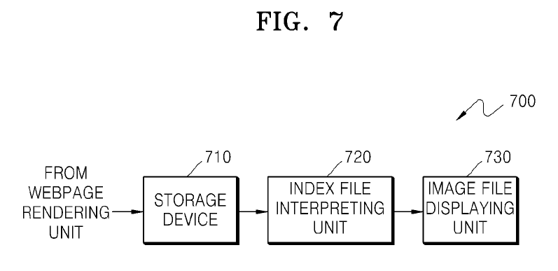

FIG. 7 is a block diagram of an apparatus 700 for displaying an image according to an exemplary embodiment of the present invention.

Referring to FIG. 7, the apparatus 700 for displaying an image includes a storage device 710, an index file interpreting unit 720, and an image file displaying unit 730.

The storage device 710 corresponds to the storage device 150 of FIG. 1 and stores the index file and the image files converted from the web pages.

The index file interpreting unit 720 reads the index file stored in the storage device 710. More specifically, the index file interpreting unit 720 extracts, from a predetermined index file, location information of the link information in the image files. The index file displaying unit 730 displays the image file having an ID corresponding to the link information of the extracted location information. For example, as described above with reference to an exemplary embodiment of FIG. 2, when a user selects the link information 201 for the web page related to ‘people’ in the first image file 210, the second image file 220 converted from the web page related to ‘people’ based on the location of link information 201 is displayed due to application of the index file. Here, the functions of minimizing, maximizing, or moving the displayed image file may be provided. Also, a function of focusing link parts and a function of navigating using keys or user pointing tools such as touch screens and the mouse may be provided.

According to the apparatus 700 for displaying an image file of the present exemplary embodiment, web pages may be viewed even though there is no connection to the Internet and there is no web browser in the apparatus 700.

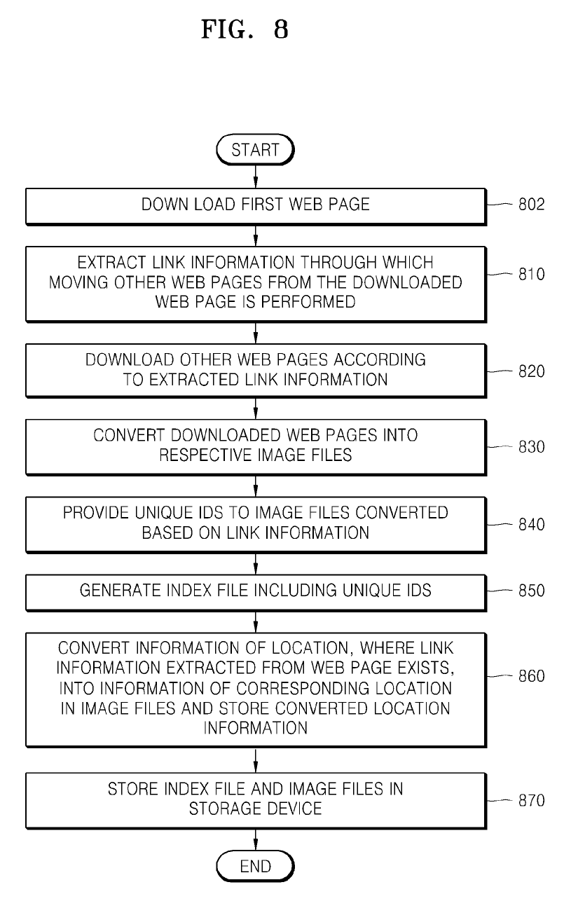

FIG. 8 is a flowchart illustrating a method of generating an image file according to an exemplary embodiment of the present invention.

Referring to FIG. 8, a first web page is downloaded, in operation 802. The link information, through which other web pages may be moved from the downloaded web page, is extracted, in operation 810. A link tag, for example, <a>, connected to another URL from the downloaded web pages is recognized and the download of web pages indicated by the link tag is requested.

The other web pages to move based on the extracted link information are downloaded, in operation 820. Contents of the URL, that is, a web page and a web page indicated by the link tag, requested by the user through a predetermined wire or wireless communication network, for example, the Internet, are downloaded.

The downloaded web pages are converted into respective image files, in operation 830.

Unique IDs are provided to the image files converted based on the link information, in operation 840. An index file including the unique IDs is generated, in operation 850. Location information of the link information in the web page is stored in the index file, in operation 860. More specifically, information of the location, where the link information extracted from the web page exists, is extracted and the information of the location is converted into information of a corresponding location in the image files. The converted location information is stored in the index file. Since the coordinates of the web page may be different from the coordinates of the image file, the location of the link information in the web page may be different from the location of the link information in the image file. When the web page is converted into the image file, the location of the link information in the web page and the location of the link information in the image file may be converted to correspond to each other, in order to have the same link information in the web page and the image file.

The index file may have a tree structure in which predetermined node information is allocated to respective nodes. The predetermined node information includes a node ID corresponding to the parent node, a child node ID, a title, a position, and a target page ID. The position denotes the coordinates of the link information located in the image file converted from the web page. The target page ID denotes an ID of the image file to move based on the link information and may be, for example, a file name of the image file. The tree structure of the index file is described above with reference to FIG. 3. The depth of node 0, which is a parent node, is ‘0.’ Node 1, node 2, and node 3 are the child nodes and the depth thereof is ‘1.’ Node 4, node 5, node 6, and node 7 are the grandchild nodes and the depth thereof is ‘2.’ According to the selection by a user, the depth level may be increased or decreased. The web page corresponding to the parent node is the requested web page, the web pages corresponding to the child nodes are the web pages linked to the web page corresponding to the parent node, and the web pages corresponding to the grandchild nodes are the web pages linked to the web pages corresponding to the child nodes. The user may determine the depth of the respective nodes.

The index file and the image files are stored in a predetermined storage device, in operation 870. The storage device may be included in the apparatus for generating image files or may be separate from the apparatus for generating image files. The storage device may be a mobile storage device which may be easily separated from the apparatus for generating image files. However, the storage device is not limited to the mobile storage device. A predetermined directory may be generated in the storage device, and the index file and the image files may be stored in the storage device. In this regard, the image files may be stored in the generated predetermined directory.

According to the present exemplary embodiment, when the image files converted from the web pages are generated and stored in the storage device, the web pages may be viewed in a mobile electronic device without connecting to a wire or wireless communication network. Also, use of the apparatus for displaying an image according to the exemplary embodiment of the present invention is advantageous in terms of cost of not using a web browser.

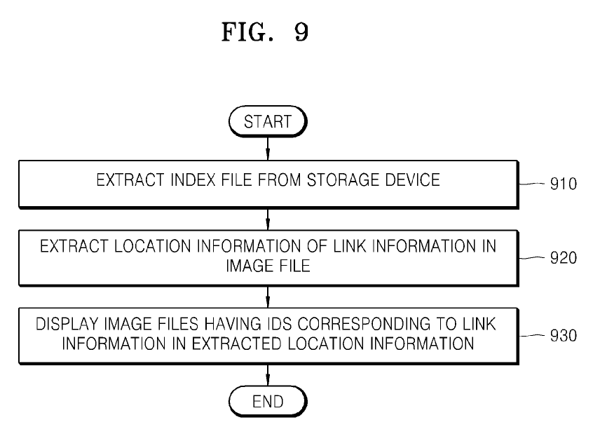

FIG. 9 is a flowchart illustrating a method of displaying an image according to another exemplary embodiment of the present invention.

In operation 910, the index file is extracted from the storage device, which stores the index file. The index file includes the unique IDs provided to the image files based on the image files converted from the web page and link information, through which movement from the web page to another web page is possible and the location information of the link information in the image files corresponding to the location information of the link information in the web page.

The location information of the link information in the image file is extracted from the extracted index file, in operation 920. The image files having IDs corresponding to the link information in the extracted location information are displayed, in operation 930. For example, if a user selects an item having link information in the image file, an image file converted from another web page based on the link information is displayed due to application of the index file.

In the method of displaying an image according to the present exemplary embodiment of the present invention, the web pages may be viewed even though there is no connection to the Internet, and there is no web browser.

The method of generating and displaying an image may also be embodied as a computer-readable code on a computer-readable recording medium. The computer-readable recording medium may include any data storage device that stores data which can be read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, functional programs, codes, and code segments for accomplishing the present invention may be construed by ones skilled in the art to which the present invention pertains.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method of generating image files, the method comprising:
obtaining a first web page;
extracting, from the first web page, link information, through which moving second web pages from the first web page is performed;
downloading the second web pages according to the extracted link information; and
converting the first and second web pages into respective image files.

2. The method of claim 1, further comprising:
providing unique identifications (IDs) to the image files based on the link information; and
generating an index file including the unique IDs.

3. The method of claim 2, further comprising storing, in the index file, location information of the link information extracted from the first web page.

4. The method of claim 3, wherein the storing the location information to the comprises:
converting the location information of the link information extracted from the first web page into corresponding location information in the image file converted from the first web page; and
storing the corresponding converted location information in the index file.

5. The method of claim 2, wherein the IDs of the image files have a tree structure in which the IDs are allocated to respective nodes.

6. The method of claim 5, wherein a depth of the tree structure is determined according to an external input signal.

7. The method of claim 2, further comprising storing the index file and the image files to a predetermined storage device.

8. A method of displaying image files, the method comprising:
extracting an index file from a storage device which stores the index file, the index file comprising unique identifications (IDs) provided to the image files converted from corresponding web pages based on link information through which moving a web page from another web page is performed, and location information of the link information in the image files corresponding to the location information of the link information in the web pages; and
displaying predetermined image files based on the extracted index file.

9. The method of claim 8, wherein the IDs of the image files have a tree structure in which the IDs are allocated to respective nodes.

10. The method of claim 8, wherein the displaying of the predetermined image files comprises:
extracting the location information of the link information in the predetermined image files from the extracted index file; and
displaying the predetermined image files having IDs corresponding to the link information in the extracted location information.

11. An apparatus for generating image files, the apparatus comprising:
a link information extracting unit which extracts, from a first web page, link information through which moving second web pages from the first web page is performed;
a web page requesting unit which downloads the second web page according to the extracted link information; and
an image file generating unit which converts the first and second web pages into respective image files.

12. The apparatus of claim 11, further comprising a web page rendering unit which provides unique identifications (IDs) to the image files based on the link information, and generates an index file including the unique IDs.

13. The apparatus of claim 12, wherein the web page rendering unit stores location information of the link information in the first web page to the index file.

14. The apparatus of claim 13, wherein the web page rendering unit converts the location information of the link information extracted from the first web page into corresponding location information in the image file converted from the first web page and stores the corresponding converted location information to the index file.

15. The apparatus of claim 12, wherein the IDs of the image files have a tree structure in which the IDs are allocated to respective nodes.

16. The apparatus of claim 15, wherein a depth of the tree structure is determined according to an external input signal.

17. The apparatus of claim 12, wherein the web page rendering unit stores the index file and the image files to a predetermined storage device.

18. An apparatus for displaying image files, the apparatus comprising:
an index file interpreting unit which extracts an index file from a storage device, which stores the index file, the index file comprising unique identifications (IDs) provided to the image files converted from corresponding web pages based on link information through which moving a web page from another web page is performed, and location information of the link information in the image files corresponding to the location information of the link information in the web pages; and
an image file displaying unit which displays predetermined image files based on the extracted index file.

19. The apparatus of claim 18, wherein the IDs of the image files have a tree structure in which the IDs are allocated to respective nodes.

20. The apparatus of claim 18, wherein the index file interpreting unit extracts the location information of the link information in the predetermined image files, and the image file displaying unit displays the predetermined image files having IDs corresponding to the link information in the extracted location information.
